(19) United States
(12) Patent Application Publication
(10) Pub. No.: US 2025/0343311 A1
(43) Pub. Date: Nov. 6, 2025

(54) BATTERY PACK INCLUDING A PARALLEL POWER SYSTEM

(71) Applicant: MILWAUKEE ELECTRIC TOOL CORPORATION, Brookfield, WI (US)

(72) Inventors: Molly K. Baerman, Milwaukee, WI (US); Douglas A. Fujimoto, New Berlin, WI (US); Jonathan Quenzer, German Valley, IL (US); Russell M. Rapant, Menomonee Falls, WI (US)

(21) Appl. No.: 19/189,742

(22) Filed: Apr. 25, 2025

Related U.S. Application Data
(60) Provisional application No. 63/641,575, filed on May 2, 2024.
(60) Provisional application No. 63/664,990, filed on Jun. 27, 2024.

(51) Int. Cl. H01M 50/269; H01M 10/42; H01M 50/247; H01M 50/296

(52) U.S. Cl. CPC H01M 50/269; H01M 10/4257; H01M 50/247; H01M 50/296; H01M 2010/4271; H01M 2010/4278

(57) ABSTRACT

A battery pack including a housing and a switching circuit. The housing supports a battery cell. The housing includes an interface for an electronic device. The interface includes a first positive power terminal and a second positive power terminal connected to the battery cell. A first negative power terminal and a second negative power terminal are connected the battery cell. The switching circuit operable to control the interface into a first configuration where power from the battery cell is only transferred from the battery cell to the electronic device using the first positive power terminal and the first negative power terminal, and control the interface into a second configuration where power from the battery cell is transferred from the battery cell to the electronic device using the first positive power terminal, the second positive power terminal, the first negative power terminal, and the second negative power terminal.

### RELATED APPLICATIONS

This application claims the benefit of U.S. Provisional Patent Application Publication No. 63/641,575, filed May 2, 2024, and U.S. Provisional Patent Application No. 63/664,990, filed Jun. 27, 2024, the entire content of each of which is hereby incorporated by reference.

### SUMMARY

Embodiments described herein relate to battery packs including a parallel power system configuration and corresponding power tools for connecting to such battery packs.

Battery packs described herein include a housing and a switching circuit. The housing supports a battery cell. The housing includes an interface configured to mechanically and electrically engage with an electronic device. The interface includes a first positive power terminal and a second positive power terminal. The first positive power terminal is connected to the battery cell. The first positive power terminal is configured to provide power from the battery cell to the electronic device. The second positive power terminal is connected to the battery cell. The second positive power terminal is configured to provide power from the battery cell to the electronic device. A first negative power terminal is connected the battery cell. A second negative power terminal is connected the battery cell. The switching circuit operable to control the interface into a first configuration where power from the battery cell is only transferred from the battery cell to the electronic device using the first positive power terminal and the first negative power terminal, and control the interface into a second configuration where power from the battery cell is transferred from the battery cell to the electronic device using the first positive power terminal, the second positive power terminal, the first negative power terminal, and the second negative power terminal.

In some aspects, the electronic device is a power tool.

In some aspects, the switching circuit includes a switch between the first negative power terminal and the second negative power terminal.

In some aspects, the battery pack further includes the switch is configured to connect the first negative power terminal to the second negative power terminal in the second configuration.

In some aspects, the second negative power terminal is configured to communicate data with the electronic device in the first configuration.

In some aspects, the interface further includes a data terminal, the data terminal including a first data communication portion and a second data communication portion, the data terminal configured to allow two-wire communication between the battery pack and the electronic device.

In some aspects, the first data communication portion is mechanically and electrically separated from the second data communication portion.

In some aspects, in the first configuration, the data terminal is configured to communicates with the electronic device using a one-wire communication, and, in the second configuration, the data terminal is configured to communicate with the electronic device using two-wire communication.

In some aspects, the battery pack further includes an electronic controller connected to the switching circuit, the electronic controller configured to control the switching circuit based on a determined type of electronic device.

Battery packs described herein include a housing, a switching circuit, and an electronic controller. The housing supports a battery cell. The housing includes an interface configured to mechanically and electrically engage with an electronic device. The interface includes a plurality of terminals. The switching circuit is connected to the battery cell and the interface. The switching circuit is operable to control the interface between a first power mode and a second power mode. The first power mode is configured to transfer power from the battery cell to the electronic device using a first pair of terminals. The second power mode is configured to transfer power from the battery cell to the electronic device using the first pair of terminals and a second pair of terminals. The electronic controller is connected to the switching circuit. The electronic controller is configured to determine whether the interface is connected to the electronic device, determine a type of electronic device connected to the interface, determine, based on the type of electronic device, a power output mode, control the switching circuit to transfer power from the battery cell to the electronic device in the first power mode upon determining the electronic device is a first type of electronic device, and control the switching circuit to transfer power from the battery cell to the electronic device in the second power mode upon determining the electronic device is a second type of electronic device.

In some aspects, the electronic device is a power tool.

In some aspects, the plurality of terminals include a first positive power terminal connected to the battery cell, the first positive power terminal configured to provide power to the electronic device, a second positive power terminal connected to the battery cell, the second positive power terminal configured to provide power to the electronic device, a first negative power terminal connected to the battery cell, and a second negative power terminal connected to the battery cell.

In some aspects, the switching circuit includes a switch between the first negative power terminal and the second negative power terminal, and wherein the switching circuit is configured to connect the first negative power terminal to the second negative power terminal.

In some aspects, the switching circuit includes a switch between the first negative power terminal and the second negative power terminal.

In some aspects, the switch is configured to connect the first negative power terminal to the second negative power terminal in the second power mode.

In some aspects, the second negative power terminal is configured to communicate data with the electronic device in the first power mode.

In some aspects, the interface further includes a data terminal, the data terminal including a first data communication portion and a second data communication portion, the data terminal configured to allow two-wire communication between the battery pack and the electronic device.

In some aspects, the first data communication portion is mechanically and electrically separated from the second data communication portion.

In some aspects, in the first power mode, the data terminal is configured to communicate with the electronic device using a one-wire communication, and wherein, in the second power mode, the data terminal is configured to communicate with the electronic device using two-wire communication.

In some aspects, the electronic controller is further configured to determine a type of electronic device based on data communicated over the data terminal.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 illustrates a battery pack, according to embodiments described herein.

FIG. 2 illustrates a control system for the battery pack of FIG. 1, according to embodiments described herein.

FIG. 3A illustrates electrical connections of the terminals of a legacy battery pack, according to embodiments described herein.

FIG. 3B illustrates electrical connections of the terminals of a battery pack including a parallel power system, according to embodiments described herein.

FIG. 4 illustrates a circuit diagram of the battery pack of FIG. 1, according to embodiments described herein.

FIG. 5A and FIG. 5B illustrate a split data terminal of the battery pack of FIG. 1, according to embodiments described herein.

FIG. 6 illustrates a power tool, according to embodiments described herein.

FIG. 7 illustrates a battery pack interface of the power tool of FIG. 6, according to embodiments described herein.

FIG. 8 illustrates a control system for the power tool of FIG. 6, according to embodiments described herein.

FIG. 9 illustrates electrical connections between a legacy power tool and a parallel power system battery pack, according to embodiments described herein.

FIG. 10 illustrates electrical connections between a parallel power system power tool and a parallel power system battery pack, according to embodiments described herein.

FIG. 11 illustrates electrical connections between a parallel power system power tool and a legacy battery pack, according to embodiments described herein.

FIG. 12 illustrates a flowchart for a process of operating a battery pack in a parallel power system mode, according to embodiments described herein.

### DETAILED DESCRIPTION

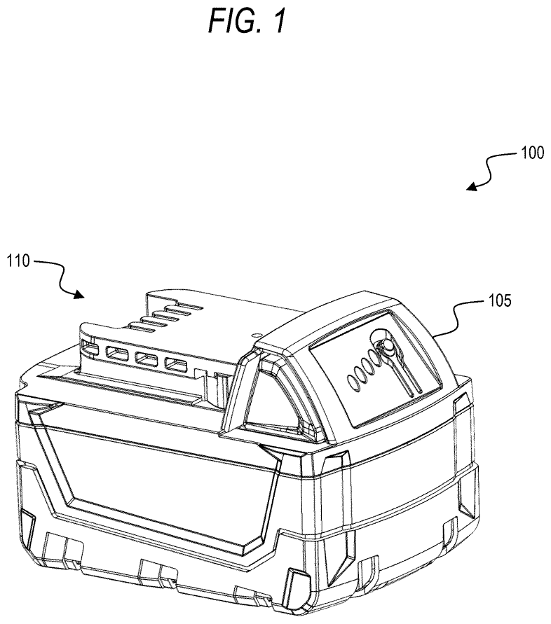

FIG. 1 illustrates a battery pack 100. The battery pack 100 includes a housing 105, at least one battery cell supported within the housing, and an interface portion 110 configured to mechanically and electrically engage the battery pack 100 to an electronic device (e.g., a power tool).

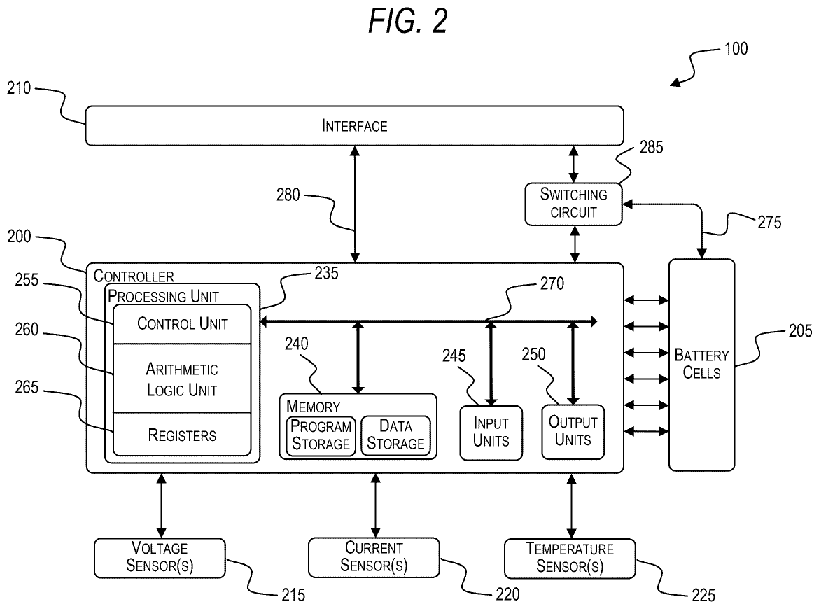

FIG. 2 illustrates a control system for the battery pack 100. The control system includes a controller 200. The controller 200 is electrically and/or communicatively connected to a variety of modules or components of the battery pack 100. For example, the illustrated controller 200 is connected to one or more battery cells 205 and an interface 210 (e.g., the interface portion 110 of the battery pack 100 illustrated in FIG. 1). The controller 200 is also connected to one or more voltage sensors or voltage sensing circuits 215, one or more current sensors or current sensing circuits 220, one or more temperature sensors or temperature sensing circuits 225, and a switching circuit 285. The controller 200 includes combinations of hardware and software that are operable to, among other things, control the operation of the battery pack 100, monitor a condition of the battery pack 100, enable or disable charging of the battery pack 100, enable or disable discharging of the battery pack 100, etc.

The controller 200 includes a plurality of electrical and electronic components that provide power, operational control, and protection to the components and modules within the controller 200 and/or the battery pack 100. For example, the controller 200 includes, among other things, a processing unit 235 (e.g., a microprocessor, a microcontroller, an electronic controller, an electronic processor, or another suitable programmable device), a memory 240, input units 245, and output units 250. The processing unit 235 includes, among other things, a control unit 255, an arithmetic logic unit (“ALU”) 260, and a plurality of registers 265 (shown as a group of registers in FIG. 2), and is implemented using a known computer architecture (e.g., a modified Harvard architecture, a von Neumann architecture, etc.). The processing unit 235, the memory 240, the input units 245, and the output units 250, as well as the various modules or circuits connected to the controller 200 are connected by one or more control and/or data buses (e.g., common bus 270). The control and/or data buses are shown generally in FIG. 2 for illustrative purposes. The use of one or more control and/or data buses for the interconnection between and communication among the various modules, circuits, and components would be known to a person skilled in the art in view of the invention described herein.

The memory 240 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 235 is connected to the memory 240 and executes software instructions that are capable of being stored in a RAM of the memory 240 (e.g., during execution), a ROM of the memory 240 (e.g., on a generally permanent basis), or another non-transitory computer readable medium such as another memory or a disc. Software included in the implementation of the battery pack 100 can be stored in the memory 240 of the controller 200. The software includes, for example, firmware, one or more applications, program data, filters, rules, one or more program modules, and other executable instructions. The controller 200 is configured to retrieve from the memory 240 and execute, among other things, instructions related to the control processes and methods described herein. In other constructions, the controller 200 includes additional, fewer, or different components.

The interface 210 includes a combination of mechanical components (e.g., rails, grooves, latches, etc.) and electrical components (e.g., one or more terminals) configured to and operable for interfacing (e.g., mechanically, electrically, and communicatively connecting) the battery pack 100 with another device (e.g., a power tool, a battery pack charger, etc.). For example, the interface 210 is configured to receive power via a power line 275 between the one or more battery cells 205 and the interface 210. The interface 210 is also configured to communicatively connect to the controller 200 via a communications line 280.

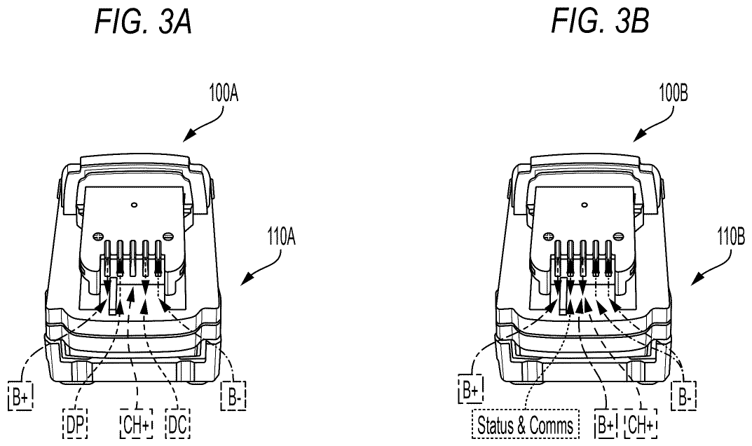

As shown in FIGS. 3A and 3B, the battery pack 100 is either a legacy battery pack 100A or a parallel power system (“PPS”) battery pack 100B. The PPS design adds a second set of power contacts in the current path to both the battery pack and tool side architecture to better distribute the energy load. Notably, the PPS design utilizes existing interface hardware from legacy battery packs. Accordingly, both the legacy battery pack 100A and the PPS battery pack 100B include an equal number of terminals and a consistent user experience is maintained when switching between the two battery pack architectures.

In the illustrated embodiment of FIG. 3A, the legacy battery pack 100A includes a power terminal (B+), a ground terminal (B−), two data terminals (DP and DC), and a charge terminal (CH+). For the legacy battery pack 100A, power is only output through the power terminal and the ground terminal, and the charge terminal is only used for recharging the battery pack 100A. The PPS battery pack 100B is operable in a legacy mode and accordingly may communicate with electronic devices using a similar terminal configuration as the legacy battery pack 100A. In the illustrated embodiment of FIG. 3B, the PPS battery pack 100B is also operable in another power configuration including two power terminals (B+), two ground terminals (B−) and one combined data terminal (Status & Comms). Notably, one of the power terminals (B+) may also serve as a charge terminal during recharging of the PPS battery pack 100. In other constructions, additional or fewer terminals may be included, and the terminals may be located in different relative positions or have different functions.

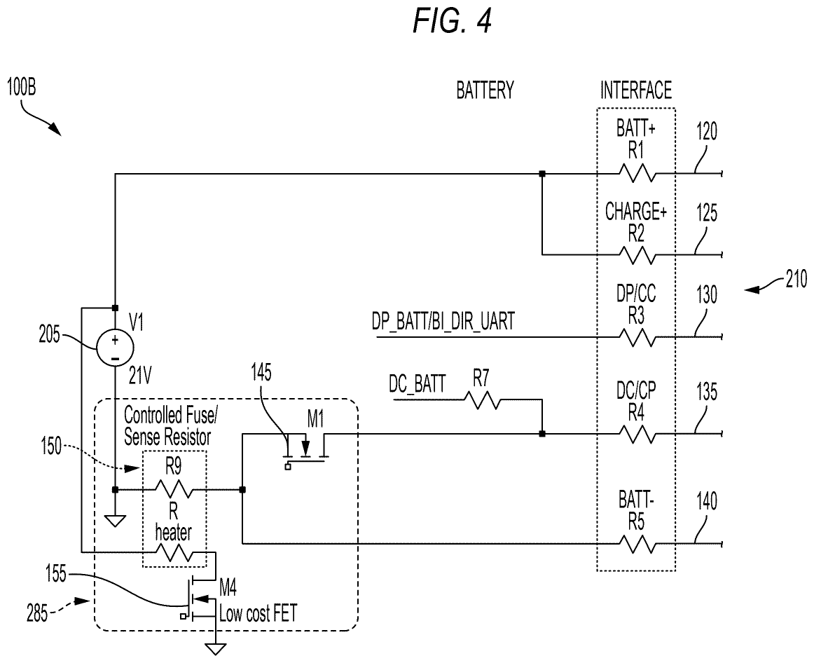

FIG. 4 illustrates a circuit diagram of the PPS battery pack 100B. As previously described, the battery pack 100B includes the plurality of battery cells 205, the interface portion 210, and the switching circuit 285. The battery pack 100B may include a plurality of battery cells connected any combination of series or parallel and configured to output power at a variety of voltages and currents. A discharge control and communications architecture are implemented to ensure battery packs and tools maintain safety functions that ensure safe and reliable power tool system operation.

The interface portion 110 defines a plurality of terminals including a first positive power terminal 120, a second positive power terminal 125, a split data terminal 130, a first negative power terminal 135, and a second negative power terminal 140. The first positive power terminal 120 and the second negative power terminal 140 are configured to respectively provide power to and sink power from a connected device. In the illustrated embodiment, the second positive power terminal 125 is directly connected to the first positive power terminal 120. In other embodiments, the second positive power terminal 125 may include a switch to operatively connect the second positive power terminal 125 to the first positive power terminal 120 during certain power applications or during charging. Accordingly, the second positive power terminal 125 can be configured to operate as both a charge terminal (CHARGE+) and as a second positive power terminal (BATT+). The split data terminal 130 is in communication with the controller 200, and is configured to allow both two-wire and one-wire communication between the battery pack and a connected device. The first negative power terminal 135 is in communication with the controller 200 and is also connectable with the second negative power terminal 140. Accordingly, the second adjustable terminal is configured to operate as both a data terminal and as a second ground terminal.

The switching circuit 285 is in communication with the controller 200 and includes a switch 145 disposed between the first negative power terminal 135 and the second negative power terminal 140 and a fuse 150 (e.g., a self-controlled fuse). The fuse 150 is disposed between the battery cells 205 and a charge switch 155. The switch 145 is controllable to short the connection between the first negative power terminal 135 and the second negative power terminal 140. Accordingly, during some operations, the switching circuit 285 may control the battery interface portion 210 to allow power to flow in parallel through multiple positive power terminals and negative power terminals. The fuse 150 may be used as a current sensor or as a component to prevent thermal runaway. For example, as a heater or heat generating component of the fuse 150 heats up, the fuse 150 is configured to create an open circuit (e.g., melt a conductive potion of the fuse 150 to prevent current flow from the battery pack 100). In other embodiments, a physical switch (e.g., a single throw, 5 pull switch) may be implemented within the switching circuit 285 to alternate the battery pack 100 between a PPS mode and a legacy mode.

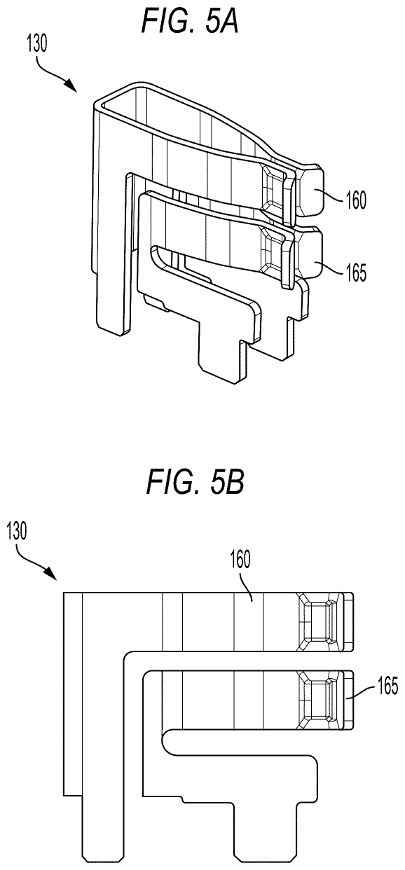

FIGS. 5A and 5B illustrate the split data terminal 130 of the PPS battery pack 100B. The data terminal 130 includes a first data node 160 and a second data node 165. The first data node 160 is mechanically and electrically separated from the second data node 165. Having two electrically isolated data nodes allows for two-wire data communication protocols (e.g., i2C communication) using the space of only one data terminal. In contrast, the legacy data terminals only allow for one-wire data communication and do not include any disconnected sections. Notably, despite being electrically isolated from one another, the data terminal 130 is still configured to use one-wire data communication when connected to a legacy device. In the illustrated example, the data nodes 160, 165 of the data terminal 130 are configured to receive one or two corresponding terminals from a connected device. When connected to a legacy device, the data nodes 160, 165 will be connected to one another by one terminal of the legacy device, thereby allowing both data nodes 160, 165 to send and/or receive the same signals. When connected to a PPS device, two terminals of the PPS device connect individually to one of the first data node 160 and the second data node 165. As a result, the data terminal 130 is configured to replace the DC and DP data terminals of a legacy battery pack with a single, split terminal.

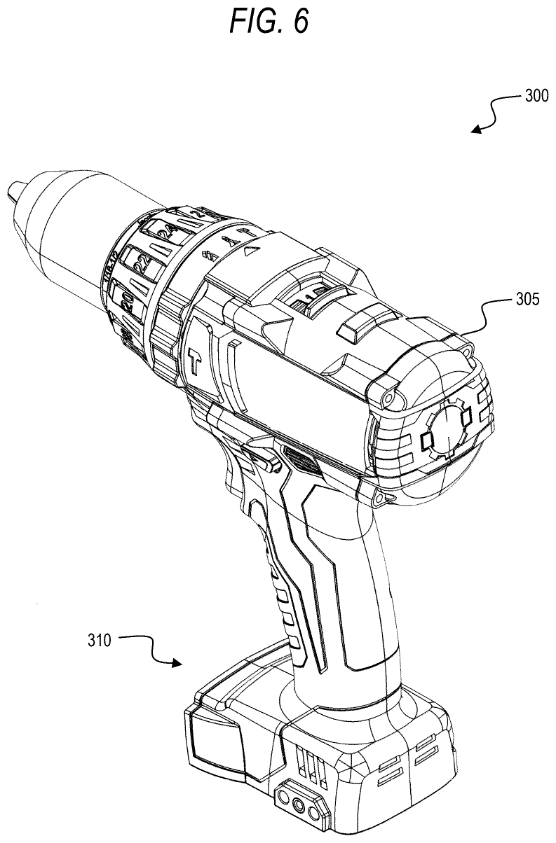

FIG. 6 illustrates a battery pack powered device 300 (e.g., a power tool 300). In the embodiment illustrated in FIG. 6, the device is a drill/driver. In other embodiments, the power tool 300 is a different type of power tool (e.g., an impact wrench, a ratchet, a saw, a hammer drill, an impact driver, a rotary hammer, a grinder, a blower, a trimmer, etc.) or a different type of device (e.g., a light, a non-motorized sensing tool, etc.). The power tool 300 includes a housing 305 and an interface portion 310 for connecting the power tool 300 to, for example, the battery pack 100 or another device. The power tool 300 can either be a legacy power tool or a PPS power tool. In the illustrated embodiment, the power tool is a PPS power tool.

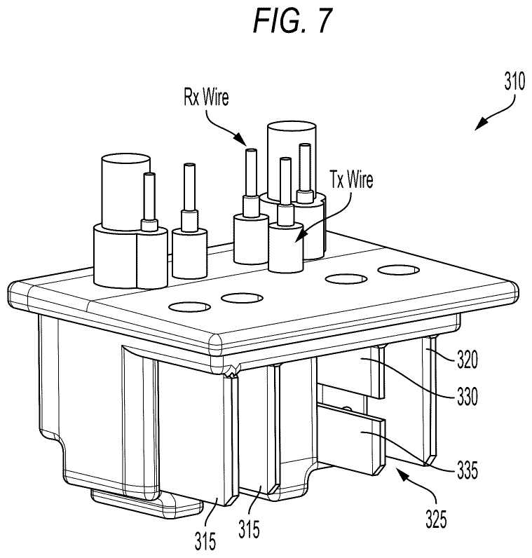

As illustrated in FIG. 7, an example interface portion 310 of the PPS power tool 300 corresponds with the PPS battery pack interface of the PPS battery pack 100B. Similar to the PPS battery pack interface, the PPS power tool interface portion 310 includes two positive power terminals 315 (e.g., for connecting to BATT+ and CHARGE+), two negative power terminals 320 (e.g., for connecting to BATT− and DC/CP), and a split data terminal 325 (e.g., for connecting to DP/CC). As with the data terminal 130 of the PPS battery pack 100B, the data terminal 325 of the power tool 300 includes two data node portions 330, 335. The first data node portion 330 and the second data node portion 335 are electrically isolated form one another and accordingly have corresponding wires connected to the controller of the power tool. As with the PPS battery pack 100B, the PPS interface of the PPS power tool 300 is operable to function with both legacy and PPS battery packs. In other embodiments, additional or fewer terminals may be included in the PPS power tool interface portion 310 and other electrical contacts may be used.

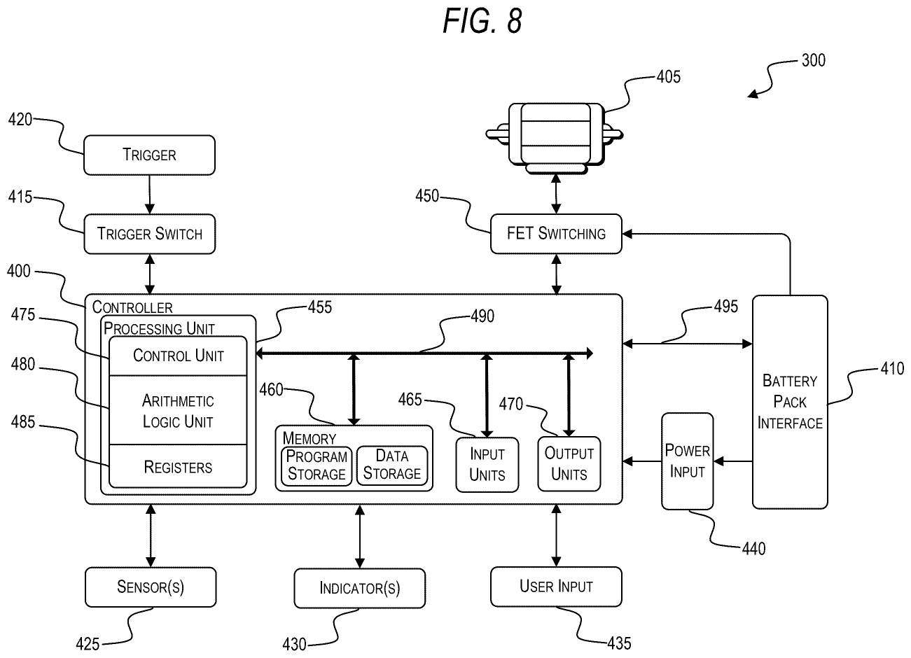

FIG. 8 illustrates a control system for the power tool 300. The control system includes a controller 400. The controller 400 is electrically and/or communicatively connected to a variety of modules or components of the power tool 300. For example, the illustrated controller 400 is electrically connected to a motor 405, a battery pack interface 410, a trigger switch 415 (connected to a trigger 420), one or more sensors or sensing circuits 425, one or more indicators 430, a user input module 435, a power input module 440, and a FET switching module 450 (e.g., including a single switching FET for a brushed motor or a plurality of switching FETs for a brushless motor). The controller 400 includes combinations of hardware and software that are operable to, among other things, control the operation of the power tool 300, monitor the operation of the power tool 300, activate the one or more indicators 430 (e.g., an LED), etc.

The controller 400 includes a plurality of electrical and electronic components that provide power, operational control, and protection to the components and modules within the controller 400 and/or the power tool 300. For example, the controller 400 includes, among other things, a processing unit 455 (e.g., a microprocessor, a microcontroller, an electronic controller, an electronic processor, or another suitable programmable device), a memory 460, input units 465, and output units 470. The processing unit 455 includes, among other things, a control unit 475, an ALU 480, and a plurality of registers 485 (shown as a group of registers in FIG. 8), and is implemented using a known computer architecture (e.g., a modified Harvard architecture, a von Neumann architecture, etc.). The processing unit 455, the memory 460, the input units 465, and the output units 470, as well as the various modules or circuits connected to the controller 400 are connected by one or more control and/or data buses (e.g., common bus 490). The control and/or data buses are shown generally in FIG. 8 for illustrative purposes. The use of one or more control and/or data buses for the interconnection between and communication among the various modules, circuits, and components would be known to a person skilled in the art in view of the invention described herein.

The memory 460 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 455 is connected to the memory 460 and executes software instructions that are capable of being stored in a RAM of the memory 460 (e.g., during execution), a ROM of the memory 460 (e.g., on a generally permanent basis), or another non-transitory computer readable medium such as another memory or a disc. Software included in the implementation of the power tool 300 can be stored in the memory 460 of the controller 400. The software includes, for example, firmware, one or more applications, program data, filters, rules, one or more program modules, and other executable instructions. The controller 400 is configured to retrieve from the memory 460 and execute, among other things, instructions related to the control processes and methods described herein. In other constructions, the controller 400 includes additional, fewer, or different components.

The battery pack interface 410 includes a combination of mechanical components (e.g., rails, grooves, latches, etc.) and electrical components (e.g., one or more terminals) configured to and operable for interfacing (e.g., mechanically, electrically, and communicatively connecting) the power tool 300 with a battery pack (e.g., the battery pack 100). For example, power provided by the battery pack 100 to the power tool 300 is provided through the battery pack interface 410 to the power input module 440. The power input module 440 includes combinations of active and passive components to regulate or control the power received from the battery pack 100 prior to power being provided to the controller 400. For example, the power input module 440 may also operate the power tool 300 in a PPS mode and a legacy mode based on the connected device. The battery pack interface 410 also includes, for example, a communication line 495 for providing a communication line or link between the controller 400 and the battery pack 100.

The indicators 430 include, for example, one or more light-emitting diodes (“LEDs”). The indicators 430 can be configured to display conditions of, or information associated with, the power tool 300. For example, the indicators 430 are configured to indicate measured electrical characteristics of the power tool 300, the status of the device, etc. The user input module 435 is operably coupled to the controller 400 to, for example, select a forward mode of operation or a reverse mode of operation, a torque and/or speed setting for the power tool 300 (e.g., using torque and/or speed switches), etc. In some embodiments, the user input module 435 includes a combination of digital and analog input or output devices required to achieve a desired level of operation for the power tool 300, such as one or more knobs, one or more dials, one or more switches, one or more buttons, etc.

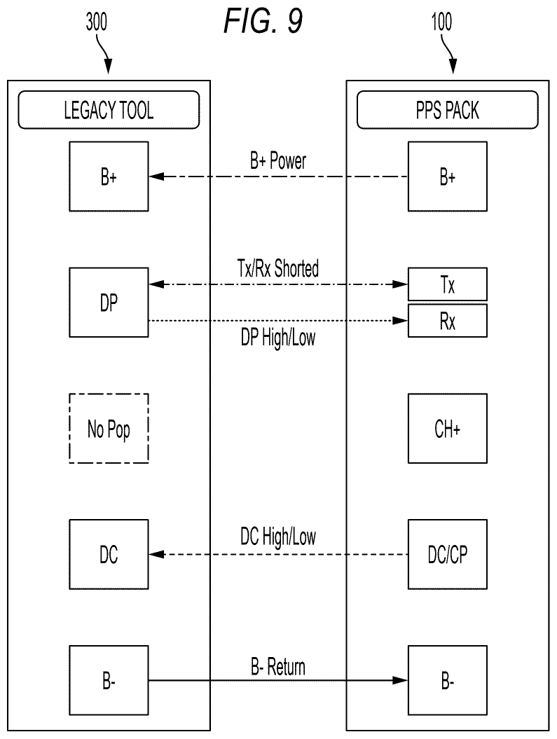

FIG. 9 illustrates the electrical connections between a legacy power tool 300 and the PPS battery pack 100B. When the PPS battery pack 100B is connected to a legacy power tool 300, the PPS battery pack 100B is configured to operate in a legacy mode. During the legacy power mode, power is only provided along one pair of positive power and negative power terminals, and data is communicated along two one-wire communication terminals (DP and DC). Notably, the legacy tool does not include a terminal configured to couple with the charge terminal of the PPS battery pack 100B. Accordingly, the PPS battery pack 100B's interface is compatible with the legacy interface.

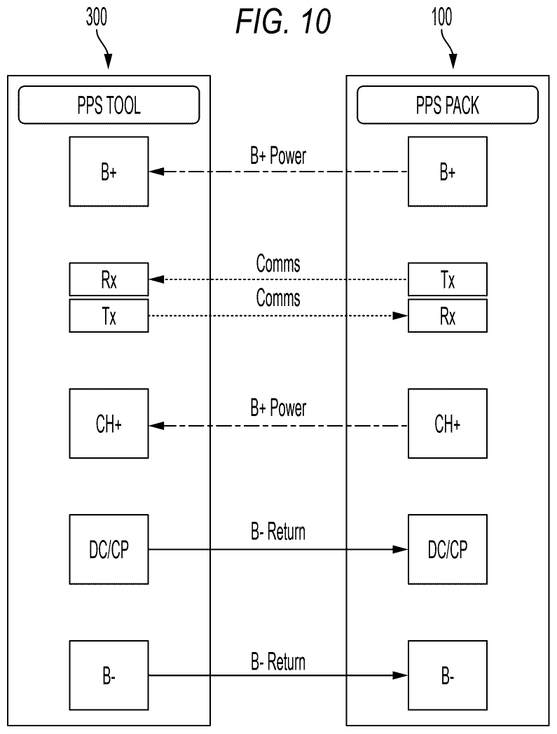

FIG. 10 illustrates the electrical connections between a PPS power tool 300 and a PPS battery pack 100B. When the PPS battery pack 100B is connected to a PPS power tool 300, power is transferred in parallel along two pairs of positive power terminals and negative power terminals, and data is communicated along one two-wire communication terminal. The first data node 160 and the second data node 165 of the data terminal 130 are shorted to provide a single terminal connection. Because multiple power paths are provided in parallel, the PPS interface allows for a larger amount of power to transfer between a PPS battery pack 100B and a PPS power tool 300 with a decreased amount of heat generation in comparison to the legacy interface.

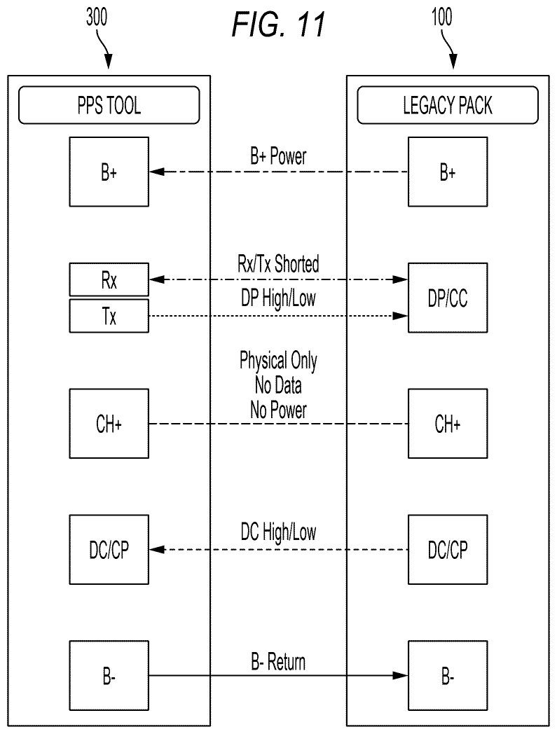

FIG. 11 illustrates electrical connections between a PPS power tool and the legacy battery pack 100A. When the legacy battery pack 100A is connected to a PPS power tool, the PPS power tool 300 is configured to operate in a legacy mode. During the legacy power mode, power is only transferred along one pair of positive and negative power terminals, and data is communicated along two one-wire communication terminals. Differing from the connection between a PPS battery pack 100B and a legacy tool 300, the PPS power tool includes a second positive power terminal configured to couple to the charge terminal of the legacy battery pack 100. In some embodiments, the PPS tool 300 may include a switch configured to prevent power transfer from the charge terminal to the PPS power tool (e.g., no data and no power).

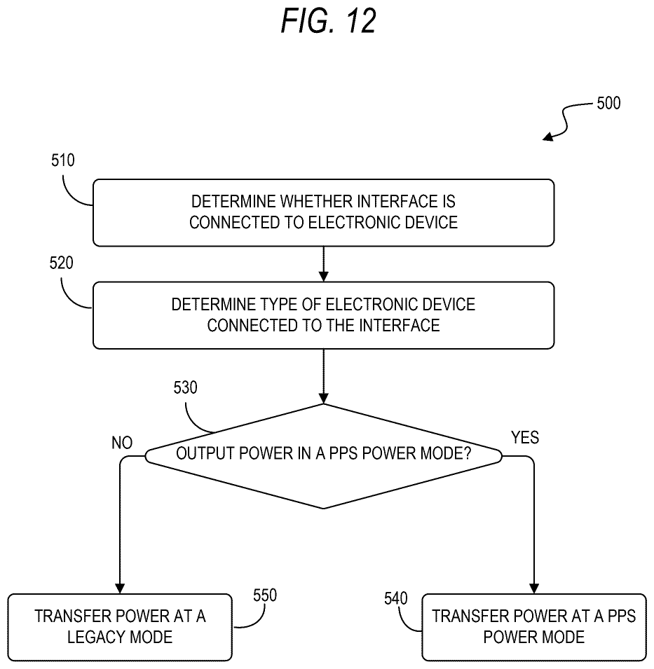

FIG. 12 illustrates a flow chart 500 of the operation of the PPS battery pack 100B. In step 510, the PPS battery pack 100B determines whether the battery pack interface (e.g., interface portion 110) is connected to an electronic device (e.g., power tool 300). To determine whether the PPS battery pack 100B is connected to a device, the controller 200 may detect a voltage on one or more terminals of the battery pack 100B, may communicate with the connected device, etc. For example, a positive voltage on a communication terminal can be indicative of the battery pack 100B being connected to a device.

In step 520, the PPS battery pack 100B is configured to determine a type of electronic device connected to the battery pack. For example, the controller 200 may communicate with the connected device using two-wire communication through the data terminal 130 to determine that the device is a PPS power tool. The data nodes 160 and 165 will have different signal or voltage values during two-wire communication. If the PPS battery pack is couple with a legacy device, the data nodes 160, 165 of the data terminal 130 will short together and accordingly only be able to communicate using one-wire communication (e.g., data nodes 160 165 have the same signal or voltage value). In other embodiments, the PPS battery pack 100B may include a physical switch or contact to determine the type of connected device. For example, a switch may be included in a recess of the housing of the PPS battery pack 100B to contact a corresponding protrusion of a PPS power tool 300.

Upon determining the type of connected power tool, the controller 200 determines an output power mode in step 530. The controller 200 determines whether to output power in the PPS mode or the legacy mode based on the attached device. In the illustrated embodiment, the PPS battery pack 100B is operable in either a PPS output mode and a legacy output mode. In other embodiments, the PPS battery pack may include other operational modes including, for example, a PPS charging mode and a legacy charging mode. In step 540, upon determining to output power in a PPS output mode, the controller 200 controls the switching circuit 285 to output power at a PPS power mode level. In step 550, upon determining not to output power in a PPS output mode, the controller 200 controls the switching circuit 285 to output power in a legacy mode.

Various features and advantages are set forth in the following claims.

What is claimed is:

1. A battery pack comprising:
a housing supporting a battery cell, the housing including an interface configured to mechanically and electrically engage with an electronic device, the interface including:
a first positive power terminal connected to the battery cell, the first positive power terminal configured to provide power from the battery cell to the electronic device,
a second positive power terminal connected to the battery cell, the second positive power terminal configured to provide power from the battery cell to the electronic device,
a first negative power terminal connected the battery cell, and
a second negative power terminal connected the battery cell, and a switching circuit operable to:
control the interface into a first configuration where power from the battery cell is only transferred from the battery cell to the electronic device using the first positive power terminal and the first negative power terminal, and
control the interface into a second configuration where power from the battery cell is transferred from the battery cell to the electronic device using the first positive power terminal, the second positive power terminal, the first negative power terminal, and the second negative power terminal.

2. The battery pack of claim 1, wherein the electronic device is a power tool.

3. The battery pack of claim 1, wherein the switching circuit includes a switch between the first negative power terminal and the second negative power terminal.

4. The battery pack of claim 3, wherein the switch is configured to connect the first negative power terminal to the second negative power terminal in the second configuration.

5. The battery pack of claim 1, wherein the second negative power terminal is configured to communicate data with the electronic device in the first configuration.

6. The battery pack of claim 1, wherein the interface further includes a data terminal, the data terminal including a first data communication portion and a second data communication portion, the data terminal configured to allow two-wire communication between the battery pack and the electronic device.

7. The battery pack of claim 6, wherein the first data communication portion is mechanically and electrically separated from the second data communication portion.

8. The battery pack of claim 6, wherein, in the first configuration, the data terminal is configured to communicates with the electronic device using a one-wire communication, and, in the second configuration, the data terminal is configured to communicate with the electronic device using two-wire communication.

9. The battery pack of claim 1, further comprising an electronic controller connected to the switching circuit, the electronic controller configured to:
control the switching circuit based on a determined type of electronic device.

10. A battery pack comprising:
a housing supporting a battery cell, the housing including an interface configured to mechanically and electrically engage with an electronic device, the interface including a plurality of terminals;
a switching circuit connected to the battery cell and the interface, the switching circuit operable to control the interface between a first power mode and a second power mode, the first power mode configured to transfer power from the battery cell to the electronic device using a first pair of terminals, and the second power mode configured to transfer power from the battery cell to the electronic device using the first pair of terminals and a second pair of terminals; and
an electronic controller connected to the switching circuit, the electronic controller configured to:
determine whether the interface is connected to the electronic device,
determine a type of electronic device connected to the interface,
determine, based on the type of electronic device, a power output mode,
control the switching circuit to transfer power from the battery cell to the electronic device in the first power mode upon determining the electronic device is a first type of electronic device, and
control the switching circuit to transfer power from the battery cell to the electronic device in the second power mode upon determining the electronic device is a second type of electronic device.

11. The battery pack of claim 10, wherein the electronic device is a power tool.

12. The battery pack of claim 10, wherein the plurality of terminals include:
a first positive power terminal connected to the battery cell, the first positive power terminal configured to provide power to the electronic device;
a second positive power terminal connected to the battery cell, the second positive power terminal configured to provide power to the electronic device;
a first negative power terminal connected to the battery cell; and
a second negative power terminal connected to the battery cell.

13. The battery pack of claim 12, wherein the switching circuit includes a switch between the first negative power terminal and the second negative power terminal, and wherein the switching circuit is configured to connect the first negative power terminal to the second negative power terminal.

14. The battery pack of claim 12, wherein the switching circuit includes a switch between the first negative power terminal and the second negative power terminal.

15. The battery pack of claim 14, wherein the switch is configured to connect the first negative power terminal to the second negative power terminal in the second power mode.

16. The battery pack of claim 12, wherein the second negative power terminal is configured to communicate data with the electronic device in the first power mode.

17. The battery pack of claim 10, wherein the interface further includes a data terminal, the data terminal including a first data communication portion and a second data communication portion, the data terminal configured to allow two-wire communication between the battery pack and the electronic device.

18. The battery pack of claim 17, wherein the first data communication portion is mechanically and electrically separated from the second data communication portion.

19. The battery pack of claim 17, wherein, in the first power mode, the data terminal is configured to communicate with the electronic device using a one-wire communication, and wherein, in the second power mode, the data terminal is configured to communicate with the electronic device using two-wire communication.

20. The battery pack of claim 17, wherein the electronic controller is further configured to:
determine a type of electronic device based on data communicated over the data terminal.
